(19) United States
(12) Patent Application Publication
(10) Pub. No.: US 2013/0169543 A1
(43) Pub. Date: Jul. 4, 2013

(54) Rendering Apparatuses, Display System and Methods for Rendering Multimedia Data Objects with a Function to Avoid Eye Fatigue

(71) Applicant: Wen-Jun Xia, Hefei City (CN)

(72) Inventor: Wen-Jun Xia, Hefei City (CN)

(73) Assignee: MEDIATEK SINGAPORE PTE. LTD., (SG)

(21) Appl. No.: 13/146,474

(22) PCT Filed: Sep. 20, 2010
(86) PCT No.: PCT/CN2010/077152

§ 371 Date: Jul. 27, 2011

(51) Int. Cl. G09G 5/00

(52) U.S. Cl. CPC G09G 5/005
USPC 345/169; 345/204

(57) ABSTRACT

A rendering apparatus is provided. A storage device stores at least one multimedia data object to be displayed. A processor obtains the multimedia data object from the storage device, determines an object type of the multimedia data object, renders the multimedia data object based on a display mode, determines whether eye fatigue of a viewer viewing the multimedia data object has occurred or is about to occur according to the object type, and adjusts the display mode for rendering the multimedia data object according to the object type when eye fatigue of a viewer has occurred or is about to occur.

### TECHNICAL FIELD

The invention relates to methods and apparatuses for rendering multimedia data objects, and more particularly to methods and apparatuses for rendering multimedia data objects with an anti-eye fatigue function for the users.

### BACKGROUND

Technology has played a role in improving the quality of life for humans. Thus, popularity of electrical appliances and electronic products which enhance quality of life continue to grow. Of the electronic products, some are designed for our visual sense, for example, three-dimensional (3D) movie broadcast equipment or virtual reality systems are designed to increase visual effect.

A 3D movie provides a stereoscopic effect (e.g., an illusion of depth) by rendering two slightly different images, wherein one image is for the right eye of a viewer (e.g., a right-eye image) and the other image is for the left eye (e.g., a left-eye image) of a viewer. When each of a viewer's eye, individually views the two slightly different images on the display, a stereoscopic image is presented.

Conventional 3D motion picture systems typically require two stereoscopically related and synchronized movie cameras (or a compound camera) to photograph a scene. The two cameras are usually positioned side by side to correspond with a viewer's left and right eye to produce stereo pictures. When the stereo pictures are reproduced on the viewing screen, usually one is projected with vertically polarized light and the other is projected with horizontally polarized light. The two pictures are superimposed and projected on the same screen. A viewer must use special eyewear with polarized filter lenses so that the left lens may filter out the right camera picture and the right lens may filter out the left camera picture. Thus, the left eye views only the left camera picture and the right eye views only the right camera picture.

However, when a viewer wears the special eyewear for a long period of time, intraocular eye pressure of a viewer increases, causing extraocular eye fatigue or, for extremely prolonged and extended use, even myopia. Therefore, methods and apparatuses for rendering multimedia data objects with a function to avoid eye fatigue for users are highly required.

### SUMMARY

Rendering apparatuses, display system and methods for rendering multimedia data objects with a function to avoid eye fatigue are provided. An embodiment of a rendering apparatus comprises at least a storage device and a processor. The storage device stores at least one multimedia data object to be displayed. The processor obtains the multimedia data object from the storage device, determines an object type of the multimedia data object, renders the multimedia data object based on a display mode, determines whether eye fatigue of a viewer viewing the multimedia data object has occurred or is about to occur according to the object type, and adjusts the display mode for rendering the multimedia data object according to the object type when eye fatigue of a viewer has occurred or is about to occur.

An embodiment of a method for rendering multimedia data objects with a function to avoid eye fatigue comprises: obtaining a multimedia data object; determining an object type of the multimedia data object; determining a display mode of the multimedia data object according to the object type; rendering the multimedia data object based on the display mode; determining whether eye fatigue of a viewer viewing the multimedia data object has occurred or is about to occur according to the object type; and adjusting the display mode for rendering the multimedia data object according to the object type when eye fatigue of a viewer has occurred or is about to occur.

Another embodiment of a display system comprises a rendering apparatus and one or more display devices. The rendering apparatus determines an object type of a multimedia data object to be displayed, determines a display mode of the multimedia data object according to the object type and renders the multimedia data object based on a display mode. The display device is coupled to the rendering apparatus and displays the rendered multimedia data object. The rendering apparatus further determines whether eye fatigue of a viewer viewing the multimedia data object has occurred or is about to occur according to the object type, and adjusts the display mode for rendering the multimedia data object according to the object type when eye fatigue of a viewer has occurred or is about to occur.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a rendering apparatus according to an embodiment of the invention;

FIG. 2 shows a display system according to an embodiment of the invention;

FIG. 3 shows another display system according to another embodiment of the invention;

FIG. 4 shows another display system according to another embodiment of the invention;

FIG. 5 shows a remote controller with a specific button for collecting timing information of users according to an embodiment of the information;

FIG. 6 shows a flow chart of a method for providing a function to avoid eye fatigue for a viewer when rendering the multimedia data object according to an embodiment of the invention; and

FIG. 7 shows a flow chart of a method for determining whether eye fatigue of a viewer has occurred, or is about to occur, according to an embodiment of the invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

FIG. 1 shows a rendering apparatus according to an embodiment of the invention. The rendering apparatus 100 for rendering multimedia data objects comprises a processor 101 and a storage device 102. The storage device 102 stores the multimedia data objects to be displayed. According to the embodiments of the invention, the storage device 102 may be a flash memory, a random access memory, a hard disc, an optical disc, or any type of storage media. The processor 101 is coupled to the storage device 102 and obtains the multimedia data objects therefrom. According to an embodiment of the invention, the processor 101 may be a central processing unit (CPU), a micro controller unit (MCU), or the likes, executing computer readable program codes embedded thereon or stored in the storage device 102 for handling the rending process of the multimedia data objects.

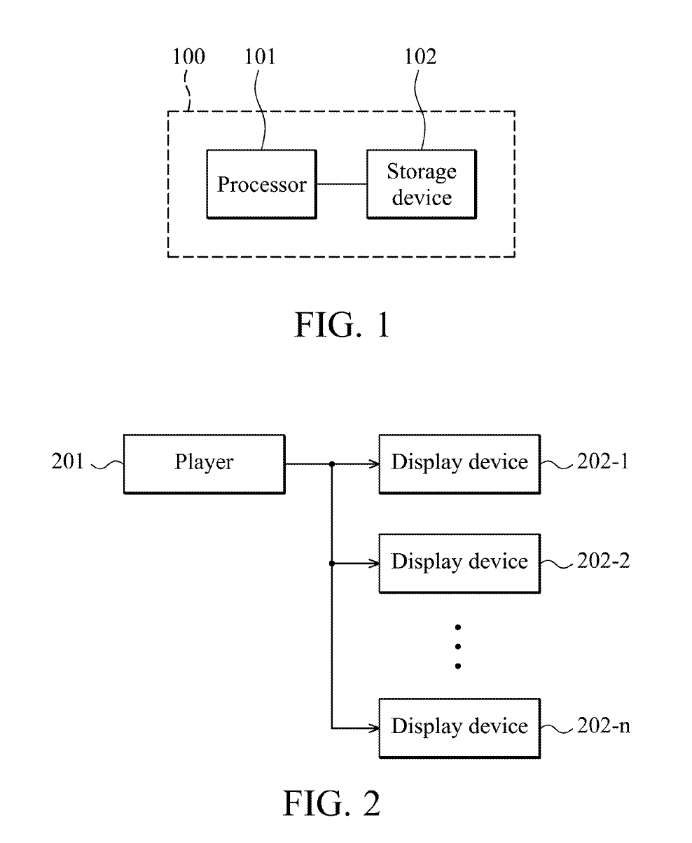

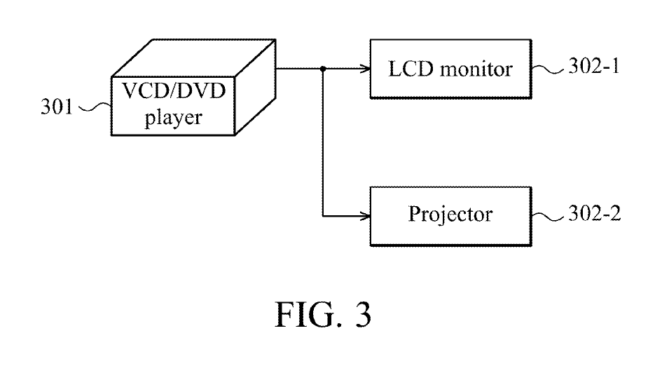

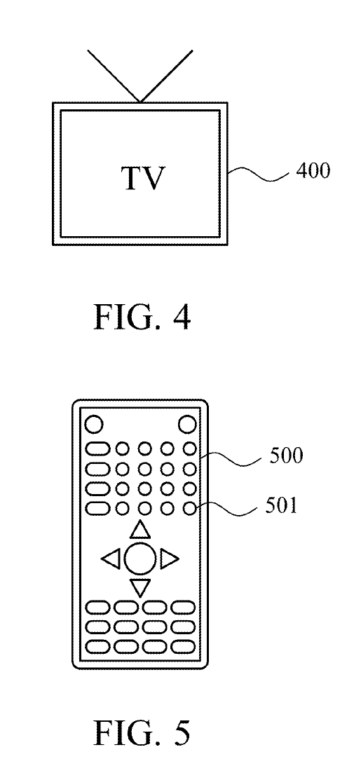

In addition to rending the multimedia data objects, the processor 101 further provides a function to avoid eye fatigue for viewers (i.e. the users of the rendering apparatus 100) viewing the multimedia data objects rendered by the rendering apparatus 100 so as to prevent the viewer from feeling eye fatigue from overuse of the extraocular eye muscle, which may even cause myopia in severe cases. Note that according to the embodiments of the invention, the rendering apparatus 100 may be implemented as an integrated circuit (IC) and/or implemented in a player device, such as the player 201 shown in FIG. 2, that is coupled to one or more display devices(s), such as the display devices 202-1˜202-n shown in FIG. 2, for displaying the multimedia data objects rendered by the player device. The player device may be any device that is capable of rendering multimedia data objects, such as a VCD/DVD player 301 shown in FIG. 3, and the display devices may be a television set, a screen monitor (such as the LCD monitor 302-1 in FIG. 3), a cell phone, a projector (such as the projector 302-2 shown in FIG. 3), or others. According to other embodiments of the invention, the rendering apparatus 100 may also be implemented in a display device that is capable of rendering and displaying the multimedia data object, such as the television set 400 shown in FIG. 4, which may receive the multimedia data objects (i.e. the TV program) via a wired cable, a wireless air interface, or from the internet.

Referring back to FIG. 1, according to the embodiments of the invention, when receiving the multimedia data object to be displayed, the processor 101 may determine an object type of the multimedia data object and render the multimedia data object based on a display mode, wherein the display mode may be selected or determined based on the object type. In the embodiment of the invention, when the multimedia data object is a film or a TV program, the object type of the multimedia data object may be a type of the film or TV program, a method of production of the film or TV program, a genre of the film or TV program, or others. To be more specific, the processor 101 may determine whether the multimedia data object is a movie or a TV program, whether the multimedia data object is produced by using 2D or 3D technology, which kind of 3D filming method (such as the Anaglyph method, Polarization method, Eclipse method, or others) is used for making the 3D multimedia data object, whether the multimedia data object is a news program, a talk show program, a drama, or others, whether the multimedia data object is a scary movie, a date movie, an epic movie, an action movie, or others. The object type may be recorded in some specific field in the header or menu of the corresponding multimedia data object. For example, when the multimedia data object is recorded in a Blue Ray disc, the format field in the header may provide such information (e.g. information about whether the recoded film is a 2D or 3D film). For another example, when the multimedia data objects are broadcasted TV programs of a digital television, the object type may be obtained from the broadcasted Electronic Program Guide (EPG).

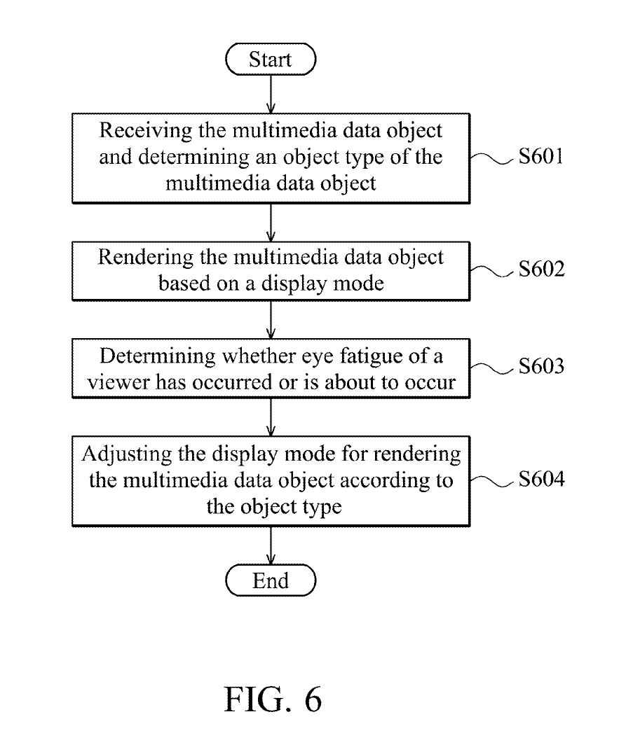

After determining the object type, the processor 101 may further determine whether eye fatigue of a viewer viewing the multimedia data object has occurred or is about to occur according to the object type when rendering of the multimedia data object begins, so as to provide an anti-eye fatigue function for a viewer. FIG. 6 shows a flow chart of a method for providing a function to avoid eye fatigue for a viewer when rendering the multimedia data object according to an embodiment of the invention. After receiving the multimedia data object and determining an object type of the multimedia data object (Step S601), the processor may begin to render the multimedia data object based on a display mode (Step S602). As previously described, the display mode may be selected or determined based on the object type. During the rendering of the multimedia data object, the processor may further obtain information regarding eye fatigue of a viewer viewing the multimedia data object and determine whether eye fatigue of a viewer has occurred or is about to occur (Step S603) based on the object type and/or the obtained information. According to an embodiment of the invention, when the processor determines that eye fatigue of a viewer has occurred, or may possibly or is about to occur, the processor may adjust the display mode for rendering the multimedia data object according to the object type (Step S604).

According to the embodiments of the invention, the information regarding eye fatigue of a plurality of users may be stored in the storage device 102 in advance. The information may be obtained by different ways. As an example, the processor may provide an interface (i.e. an User Interface, UI, in the home menu or a specific menu) to interact with the users so as to collect timing information, such as the time when users begin to feel tired or eyes begin to feel fatigued, or the anti-eye fatigue time (that is, the time after the anti-eye fatigue time has expired, for when a user would like to be reminded to close his/her eye and relax) set by the users, analyze the collected timing information of each user so as to obtain habits of users, and store the obtained habits for each user as the information regarding eye fatigue of the corresponding users.

Some specific embodiments for the processor 101 to obtain the information regarding eye fatigue of a plurality of users are given in the following paragraphs. However, it is understood that the invention is not limited thereto. According to an embodiment of the invention, the processor 101 may first identify an identity of the user. The identification may be made by identifying fingerprints of the user (for example, via a remote controller 500 as shown in FIG. 5 operated by the user to control the operations of the rendering apparatus 100), or by receiving some identity information input by the users via the UI provided by the rendering apparatus 100. After the user inputs their identity information, either via his fingerprints or via the UI, corresponding message carrying information regarding the identity of the user is obtained by the processor 101.

After the user is identified, the processor 101 may provide another interface to interact with the user so that the user may input his/her habits, or so-called timing information, for example, the time for when the user may begin to feel tired or eyes begin to feel fatigued, or the anti-eye fatigue time as previously described. The processor 101 may receive a response message carrying timing information input by the user. In some embodiments of the invention, the processor 101 may also obtain timing information of the user via a specific button on the remote controller. The button, such as the button 501 in the remote controller 500 as shown in FIG. 5, may be specially made for collecting timing information. For example, once the user feels tired or eyes begin to feel fatigued when watching a film or a TV program, the user may press the specific button 501 (i.e., change the specific button 501 from one state to another state) to notify the processor 101. A notification message may be transmitted from the remote controller to the processor 101 after the specific button 501 is pressed. After receiving the notification message, the processor 101 may adjust the display mode as in step S604 and further calculate the time when users begin to feel tired or eyes begin to feel fatigued in response to the received notification message. For example, the processor 101 may determine how long the user has been watching the film or TV program, and thereby obtain timing information. In either the user input or button pressing method, the corresponding response message or notification message comprising information regarding eye fatigue of the users may be obtained by the processor 101. The processor 101 may next store the obtained information in the storage device 102 for future use.

Note that according to the embodiments of the invention, the information regarding eye fatigue of the users may be stored with respect to different users, and even with respect to different object types. To be more specific, the processor 101 may store the information regarding eye fatigue for different users, respectively. Further, for each user, the information regarding eye fatigue (hereinafter called fatigue information for brevity) may further be categorized according to different object types. For example, the processor 101 may respectively store the fatigue information for the user viewing a 2D film, a 3D film, News, drama, or others. As another example, the processor 101 may further respectively store the fatigue information for the user viewing different genres of movies, such as a scary movie, a date movie, an epic movie, an action movie, or others. The fatigue information may be stored in a form of a table in the storage device 102, and when required, the processor 101 may obtain the fatigue information for a specific user and/or a specific object type by looking up the table.

According to another embodiment of the invention, the processor 101 may also store the fatigue information regarding one or more than one specific object type for the users in the storage device 102, and derive the fatigue information regarding other object types that are not stored in the storage device 102 according to a predetermined rule. As an example, the processor 101 may store the fatigue information of a user regarding a 2D film (e.g. the time for when the user may begin to feel tired or eyes begin to feel fatigued, or the anti-eye fatigue time when viewing a 2D film), and derive the fatigue information regarding a 3D film of the user based on the fatigue information regarding the 2D film. To be more specific, when the fatigue information regarding the 2D film is 2 hours, the processor 101 derives the fatigue information regarding the 3D film by, for example multiplying 2 by a predetermined value (such as 0.75) to obtain the fatigue information (such as 1.5 hours) for the 3D film. Therefore, after rendering a 3D multimedia data object for 1.5 hours, the processor 102 may adjust the display mode (which will be discussed in more detailed in the following paragraphs). In this manner, it is more efficient for users, as they do not have to input the fatigue information for each object type manually, and the memory space required for storing the fatigue information may also be optimized.

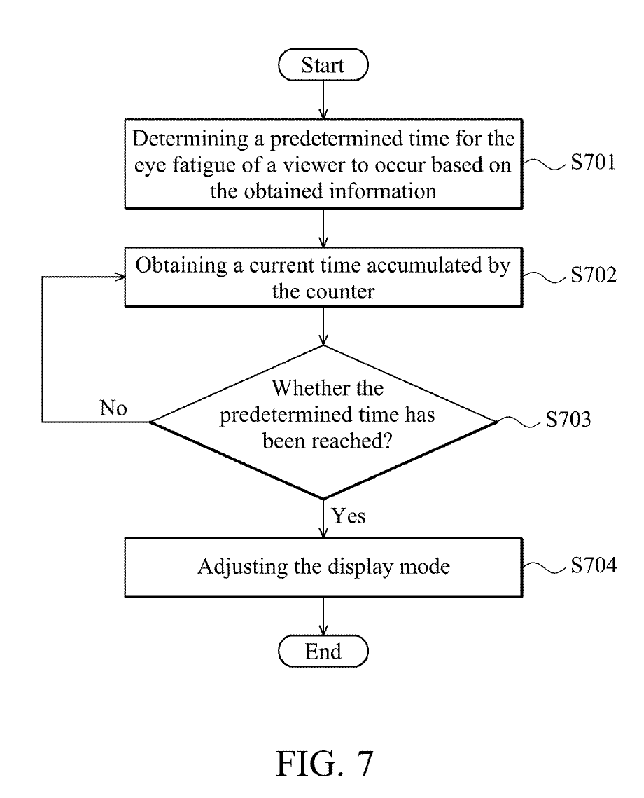

FIG. 7 shows a flow chart of a method for determining whether eye fatigue of a viewer has occurred, or is about to occur, according to an embodiment of the invention. After determining the object type and/or obtaining information regarding eye fatigue of a viewer, the processor 101 may determine a predetermined time for the eye fatigue of a viewer to occur based on the obtained information (step S701). As the example previously described, the predetermined time may be 2 hours for a 2D film, or 1.5 hours for a 3D film, or others. Next, the processor 101 may start a timer when beginning to render the multimedia data object and periodically check the counter to obtain a current time accumulated by the counter (step S702). Next, the processor 101 may further determine whether the predetermined time has been reached (Step S703). When the predetermined time has been reached, the processor may adjust the display mode (Step S704). Otherwise, the process returns to step S702. Note that the method shows one of the embodiments that may be utilized in Step 603. According to other embodiments of the invention, the processor 101 may also determine whether eye fatigue of a viewer has occurred or is about to occur according to other methods. As an example, as previously described, the processor 101 may determine that eye fatigue of a viewer has occurred or is about to occur when the viewer presses the specific button 501 as shown in FIG. 5.

According to the embodiments of the invention, the processor 101 may adjust the play mode in several ways. In an embodiment of the invention, when rendering a 3D film, the processor may adjust the display mode for rendering the multimedia data object by transforming the display mode from a 3D display mode to a 2D display mode for rendering the 3D film when determining that eye fatigue of a viewer has occurred or is about to occur. In another embodiment of the invention, the processor 101 may generate a warning message when determining that eye fatigue of a viewer has occurred or is about to occur and renders the warning message via the UI to notify the viewer. The processor 101 may notify the viewer that the time for viewing has been long, and query the viewer whether he/she would like to take a short break to relax his/her eyes, or adjust the display mode. The processor may also stop rendering the multimedia data object, either directly or after receiving an agreement message from the viewer, when determining that eye fatigue of a viewer has occurred or is about to occur. In yet another embodiment of the invention, when the rendering apparatus 100 is coupled to more than one display device for displaying the multimedia data object as shown in FIG. 2 or FIG. 3, the processor 101 may also output the rendered multimedia data object to a display device other than a previous one when determining that the eye fatigue of a viewer has occurred or is about to occur. Because different display devices may cause the timing for eye fatigue for users to be different, the processor 101 may choose another display device for rendering the remaining time for the multimedia data object when needed.

In addition, according to another embodiment of the invention, the rendering apparatus 100 may further provide an additional anti-eye fatigue function for young viewers. Because young viewers usually do not strictly monitor and control their behavior, after generating and rendering a warning message via the UI to notify the viewer, the processor 101 may further lock the screen until a password is entered. The password may be set by the parents of the young viewers so that the processor 101 may stop rendering the multimedia data object until the password is entered. In this manner, parents may not have to worry about eye fatigue for their children when viewing a multimedia data object.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

1. A rendering apparatus, comprising:
a storage device, storing at least one multimedia data object to be displayed; and
a processor, obtaining the multimedia data object from the storage device, determining an object type of the multimedia data object, rendering the multimedia data object based on a display mode, determining whether eye fatigue of a viewer viewing the multimedia data object has occurred or is about to occur according to the object type, and adjusting the display mode for rendering the multimedia data object according to the object type when eye fatigue of a viewer has occurred or is about to occur.

2. The rendering apparatus as claimed in claim 1, wherein the multimedia data object is a film and the object type of the multimedia data object comprises a method of production of the film and/or a genre of the film.

3. The rendering apparatus as claimed in claim 1, wherein when the multimedia data object is a three-dimensional (3D) film, the processor adjusts the display mode for rendering the multimedia data object by transforming the display mode from a 3D display mode to a 2D display mode for rendering the 3D film.

4. The rendering apparatus as claimed in claim 1, wherein the processor further obtains information regarding eye fatigue of a plurality of users by identifying an identity of the users, providing an interface to interact with the users, receiving a response message comprising information regarding eye fatigue of the users via the interface, and stores the information in the storage device.

5. The rendering apparatus as claimed in claim 4, wherein the processor identifies the identity of the users by identifying fingerprints of the users or receiving a message comprising information regarding identity of the users via the interface.

6. The rendering apparatus as claimed in claim 1, wherein the processor further generates a warning message when determines the eye fatigue of a viewer has occurred or is about to occur, and renders the warning message to notify the viewer.

7. The rendering apparatus as claimed in claim 1, wherein the processor further obtains information regarding the eye fatigue of a viewer, determines a predetermined time for the eye fatigue of a viewer to occur based on the information, starts a timer when begins to render the multimedia data object, and adjusts the display mode when a current time of the timer reaches the predetermined time.

8. The rendering apparatus as claimed in claim 7, wherein when the multimedia data object is a 3D film and the information regarding the eye fatigue of a viewer is a fatigue time for the viewer viewing a 2D film, the processor further determines the predetermined time for viewing the 3D film by transforming the fatigue time for viewing the 2D film according to a predetermined rule.

9. The rendering apparatus as claimed in claim 1, wherein when being coupled to more than one display devices for displaying the multimedia data object, the processor further outputs the rendered multimedia data object to a display device other than a previous one when determining that the eye fatigue of a viewer has occurred or is about to occur.

10. The rendering apparatus as claimed in claim 1, wherein the processor further stops rendering the multimedia data object when determining that the eye fatigue of a viewer has occurred or is about to occur.

11. A rendering method for rendering multimedia data objects with a function to avoid eye fatigue comprising:
obtaining a multimedia data object;
determining an object type of the multimedia data object;
determining a display mode of the multimedia data object according to the object type;
rendering the multimedia data object based on the display mode;
determining whether eye fatigue of a viewer viewing the multimedia data object has occurred or is about to occur according to the object type; and
adjusting the display mode for rendering the multimedia data object according to the object type when eye fatigue of a viewer has occurred or is about to occur.

12. The method as claimed in claim 11, wherein the multimedia data object is a film and the object type of the multimedia data object comprises a method of production of the film and/or a genre of the film.

13. The method as claimed in claim 11, wherein when the multimedia data object is a three-dimensional (3D) film, the processor adjusts the display mode for rendering the multimedia data object by transforming the display mode from a 3D display mode to a 2D display mode for rendering the 3D film.

14. The method as claimed in claim 11, further comprising:
identifying an identity of a user;
providing an interface to interact with the user;
receiving a response message comprising information regarding eye fatigue of the users via the interface; and
storing the information for each user.

15. The method as claimed in claim 14, wherein the identifying step is performed by identifying fingerprints of the user or receiving a message comprising information regarding identity of the user via the interface.

16. The method as claimed in claim 11, further comprising:
generating a warning message when determines the eye fatigue of a viewer has occurred or is about to occur; and
rendering the warning message to notify the viewer.

17. The method as claimed in claim 11, further comprising:
obtaining information regarding the eye fatigue of a viewer;
determining a predetermined time for the eye fatigue of a viewer to occur based on the information;
starting a timer when begins to render the multimedia data object; and
adjusting the display mode when a current time of the timer reaches the predetermined time.

18. The method as claimed in claim 17, wherein when the multimedia data object is a 3D film and the information regarding the eye fatigue of a viewer is a fatigue time for the viewer viewing a 2D film, the determining step is performed by transforming the fatigue time for viewing the 2D film according to a predetermined rule so as obtain to the predetermined time for viewing the 3D film.

19. The method as claimed in claim 11, further comprising:
stop rendering the multimedia data object when determining that the eye fatigue of a viewer has occurred or is about to occur.

20. A display system, comprising:
a rendering apparatus, determining an object type of a multimedia data object to be displayed, determining a display mode of the multimedia data object according to the object type and rendering the multimedia data object based on a display mode; and
at least one display device, coupled to the rendering apparatus and displaying the rendered multimedia data object,
wherein the rendering apparatus further determines whether eye fatigue of a viewer viewing the multimedia data object has occurred or is about to occur according to the object type, and adjusts the display mode for rendering the multimedia data object according to the object type when eye fatigue of a viewer has occurred or is about to occur.

21. The display system as claimed in claim 20, wherein there are more than one display devices coupled to the rendering apparatus, the rendering apparatus further outputs the rendered multimedia data object to a display device other than a previous one when determining that the eye fatigue of a viewer has occurred or is about to occur.

22. The display system as claimed in claim 20, further comprising:
a remote controller, comprising a button for collecting information regarding the eye fatigue of a viewer,
wherein when the button is changed from one state to another state, the remote controller further transmits a notification message to the rendering apparatus, and the rendering apparatus calculates the time for the viewer to feel tired or eyes begin to feel fatigued in response to the received notification message.

23. The display system as claimed in claim 22, wherein the processor further adjusts the display mode in response to the received notification message.
